(19) United States
(12) Patent Application Publication
(10) Pub. No.: US 2020/0289887 A1
(43) Pub. Date: Sep. 17, 2020

(54) SYSTEM AND METHOD FOR OFFICIATING IN A GAME OF SPORT

(71) Applicant: Brian King Simpson, Telford, PA (US)

(72) Inventor: Brian King Simpson, Telford, PA (US)

(21) Appl. No.: 16/559,167

(22) Filed: Sep. 3, 2019

Related U.S. Application Data
(63) Continuation-in-part of application No. 29/681,780, filed on Mar. 18, 2019, now abandoned.
Application No. 29/681,780 is a continuation-in-part of application No. 29/683,196, filed on Mar. 12, 2019, now abandoned.

(51) Int. Cl. A63B 24/00; A63B 71/06; A63F 13/30; A63F 13/795

(52) U.S. Cl. CPC A63B 24/0021; A63B 71/0605; A63F 13/30; A63B 2043/001; A63B 2225/50; A63B 2220/12; A63F 13/795

(57) ABSTRACT

A method and system of officiating a sporting event with a player on a field of play with a play boundary is disclosed. A ball sensor in a ball of sport and a player sensor in player equipment may be detected when breaking a detection field generated by a field generator along a play boundary. Play data and participant data may be sent to a processor to determine an officiating result, and the officiating result may be sent to an official's mobile device for confirmation.

### CROSS REFERENCE TO RELATED APPLICATIONS

This application is related to, and claims priority to, U.S. application Ser. No. 29/681,780 filed on Mar. 18, 2019 the contents of which are hereby incorporated by reference, and to U.S. application Ser. No. 29/683,196 filed on Mar. 12, 2019 the contents of which are hereby incorporated by reference.

### BACKGROUND

### 1. Technical Field

This disclosure relates to methods and systems for officiating in a sport game played on a field with an object of play.

### 2. Background Art

Many sporting events are played on a field or an area with boundaries and use an object of play, such as football, soccer, basketball, hockey, and others. The sporting events often are played for entertainment for fans of the game. A common frustration of fans of the game is the officiating results from officials who are determining play results including scoring, fouls, penalties and other officiating results. A system and method is need to improve the accuracy, consistency and efficiency of determining officiating results in spectator sports.

### BRIEF SUMMARY

A method and system of officiating a sporting event with a player on a field of play with a play boundary is disclosed. A ball sensor in a ball of sport and a player sensor in player equipment may be detected when breaking a detection field generated by a field generator along a play boundary. Play data and participant data may be sent to a processor to determine an officiating result, and the officiating result may be sent to an official's mobile device for confirmation.

### BRIEF DESCRIPTION OF THE DRAWINGS

FIG. 1a is a top view of an embodiment of a ball of sport with sensors.

FIG. 1b is a front view of an embodiment of a ball of sport with sensors.

FIG. 1c is a bottom view of an embodiment of a ball of sport with sensors.

FIG. 1d is a rear view of an embodiment of a ball of sport with sensors.

FIG. 2 is an end perspective view of an embodiment of a field of play.

FIG. 3 is a side perspective view of an embodiment of a field of play.

FIG. 4 is a top view of an embodiment of a field of play.

FIG. 5 is an illustrative front view of player's equipment with sensors placed throughout the equipment.

FIG. 6 is an illustrative side view of player's equipment with sensors placed throughout the equipment.

FIG. 7 is an illustrative rear view of player's equipment with sensors placed throughout the equipment.

FIG. 8 is an illustrative system for assisting in officiating in a sporting event.

### DETAILED DESCRIPTION

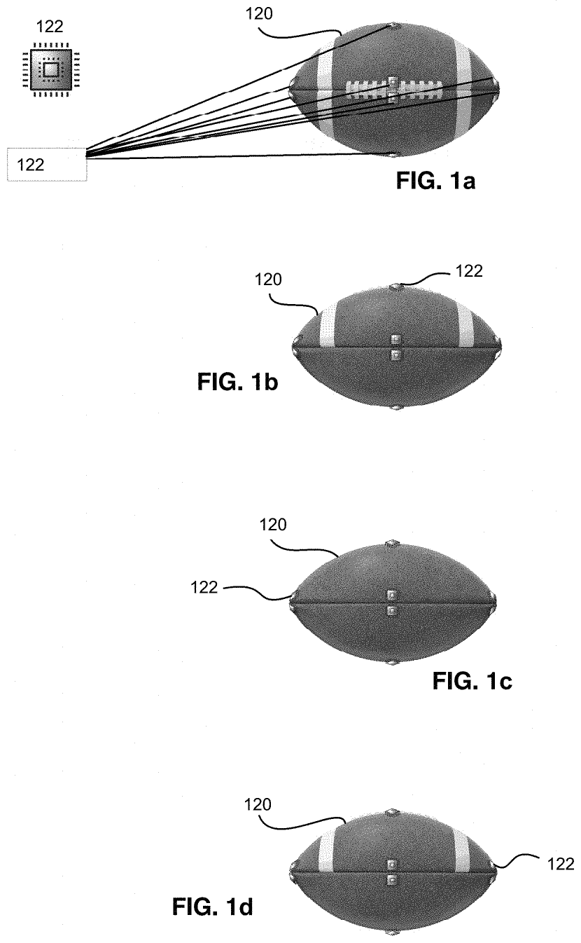

FIG. 1 shows example views of a ball of sport 120 with a ball sensor 122. The ball of sport 120 shown is a football in this example, but it may be any type of object of play including, but not limited to a ball, a football (American, Australian or other rules), a soccer ball (association football), a basketball, a lacrosse ball, a hockey puck, a field hockey ball, a baseball, a cricket ball, a tennis ball, a volley ball, a table tennis (ping pong) ball, a golf ball, a rugby ball, a water polo ball, a croquet ball, a billiard ball, a racquet ball, a hand ball, a bocce ball, a squash ball, a softball, a bowling ball, a dodge ball, a kick ball, a Whiffle™ ball, a marble, a water balloon, a Frisbee™, a hurling ball (sliotar) or a curling stone.

The example embodiment shown in FIGS. 1a-1d show example positions of multiple ball sensors 122 on the exterior of a ball of sport. In some embodiments the ball sensors 122 are between a bladder and a skin of the ball, and are placed at locations to determine the location of the ball. The sensors may be placed in multiple parts of the ball so that when a part of the ball with a sensor crosses a boundary with a detection field, or breaks the detection field, the detection field will be able to determine that the ball of sport has crossed the game boundary on the field of play. In the example embodiment of FIGS. 1a-1d sensors are placed at the long ends of the football and in multiple locations around the circumference of the center of the football, so that when one of the multiple sensors breaks the detection field, data will be sent that the ball of sport has broken the boundary. In other balls of sport where a ball is round or near round, ball sensors 122 may be placed near the edge of the ball, or on the exterior of the ball, in multiple locations such as multiple circumferences. In a soccer ball, a sensor may be placed in each of the patches that make up the soccer ball, or on the underside of each of the patches.

In some embodiments there are multiple types of sensors in the ball of sport 120. A ball of sport 120 may have a position sensor, or multiple position sensors, to determine position on the field of play. A ball of sport 120 may have an accelerometer sensor to determine impacts, direction of travel and acceleration. A ball of sport 120 may have an attitude sensor that can determine pitch, roll and yaw (azimuth) angles and may determine a spin or rate of rotation of the ball of sport 120. A ball of sport 120 may have an altimeter sensor that can determine the altitude of the ball of sport. A ball of sport may include a vibration sensor, a tilt sensor, a magnetometer, a proximity sensor, a global positioning system (GPS) sensor, and or other sensors. While some embodiments have multiple ball sensors 122 in a ball of sport 120, other embodiments may have a single ball sensor 122 in a ball of sport 120.

In some embodiments a manufacturer of the ball of sport 120 may insert as many sensors as needed, potentially of different types, into a specific ball of sport 120, so they become detectable by a sensor field, and utilized to assist in the officiating of sporting events. When a ball sensor 122 in a ball of sport 120 breaks a sensor detection field 110 a processor 140 may receive indication that the ball of sport 120 has crossed the sensor detection field 110. The processor may determine an officiating result and may use the officiating result to assist in officiating in a sporting event.

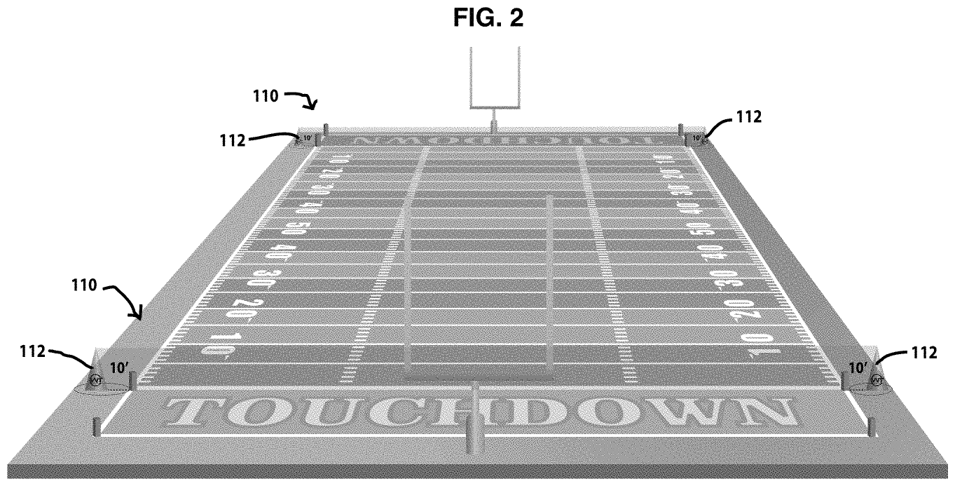

FIG. 2 shows an illustrative view depicting a full length playing field with two sensor detection fields 110, two sets of sensor arrays 112 that are each part of a field generator, and indicator lights aligned at the front of the end zones, which are play boundaries. The field generators create a sensor detection field 110 overlapping the front edge of both end zone goal lines. The sensor arrays 112 may be outside of the field of play for player safety and so that they do not interfere with the play on the field of play. In the example illustration of FIG. 2 the sensor arrays 112 are set back from the side lines by ten feet.

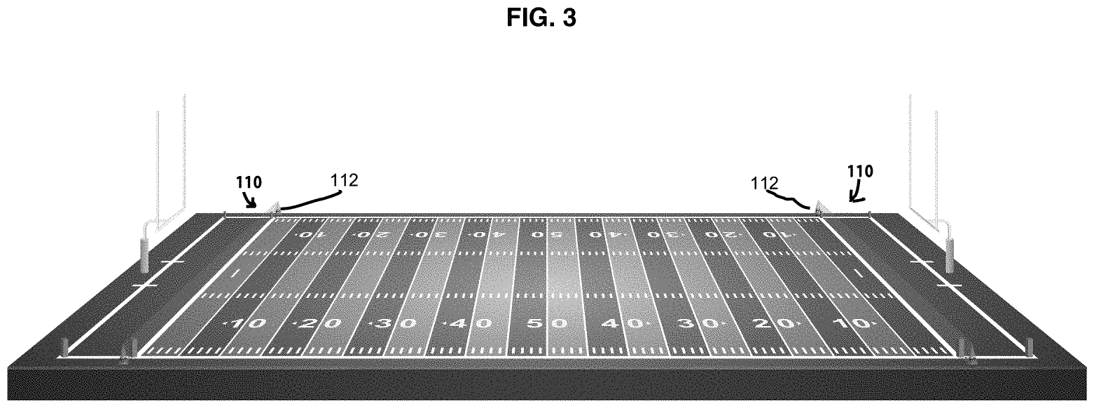

FIG. 3 shows an illustrative side view, depicting a full-length field of play with two sensor detection fields 110, two sets of sensor arrays 112 and indicator lights aligned at the front of both end zones along a play boundary, overlapping the front edge of both goal lines. In the example illustration the sensors arrays are recessed from the field of play as discussed above. In some embodiments the sensor arrays 112 include visual indicators which indicate when an officiating result occurs. For example, if the game of sport is American football, and a player breaks the boundary of the endzone, the officiating result may be reflected by lights, or a light display on the sensor arrays 112. Providing lights on the sensor arrays 112 may enhance the entertainment experience for fans of the game. In some embodiments lights indicate the officiating result after an official confirms the officiating result. In other embodiments the lights may automatically indicate an officiating result when a processor determines the data received indicates the officiating result.

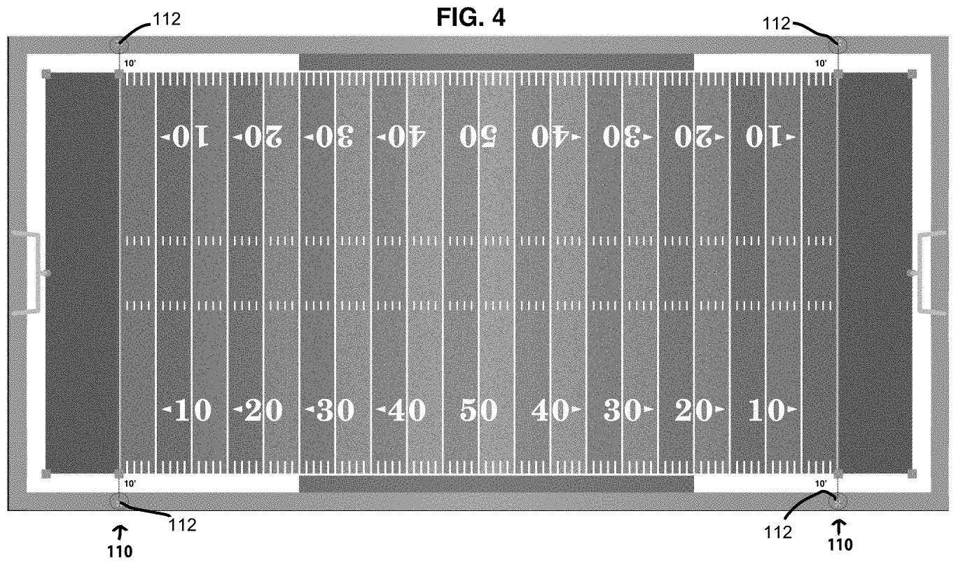

FIG. 4 shows an illustrative aerial view, depicting a full-length playing field, with two sensor detection fields 110, two sets of sensor arrays 112 and indicator lights aligned at the front edge of both goal lines. The illustrated detection fields in FIGS. 2-4 are shown as ten feet high by way of example. In some embodiments the sensor detection fields are thirty feet high. In some embodiments the sensor arrays are movable to create a detection field over different parts of the field, such as a first down line that may be in different locations during a game. In some embodiments a detection field may be along the lines that determine whether a player 130 or a ball of sport 120 is out of bounds.

In some embodiments sensors are placed throughout sports equipment and may be used in conjunction with other data gathering electronics to gather data, such as impact data, velocity data, location data, whether the sensors compromised sensor array fields, temperature data. Data may be captured and analyzed so it can be utilized to develop safer player equipment, determine a player's global positioning, assist athletes with improving their training regimens, assist in evaluating an athlete's physical traits and capabilities and assist in the officiating of sporting events.

An system may detect and track player 130 and equipment movement that is captured from sensors placed throughout a player's equipment that may generate data that can be captured, analyzed and utilized to develop safer player equipment, determine a player's global positioning, assist athletes with improving their training regimens, assist in evaluating an athlete's physical traits and capabilities and/or assist in the officiating of sporting events.

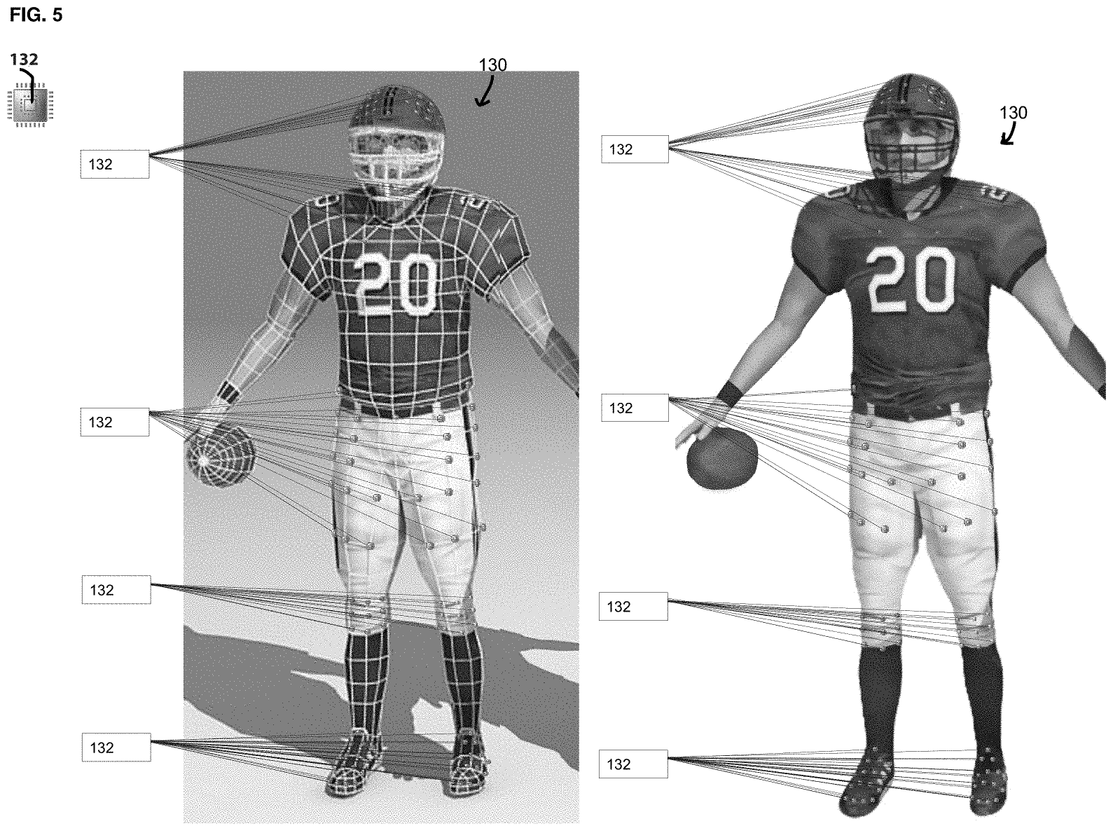

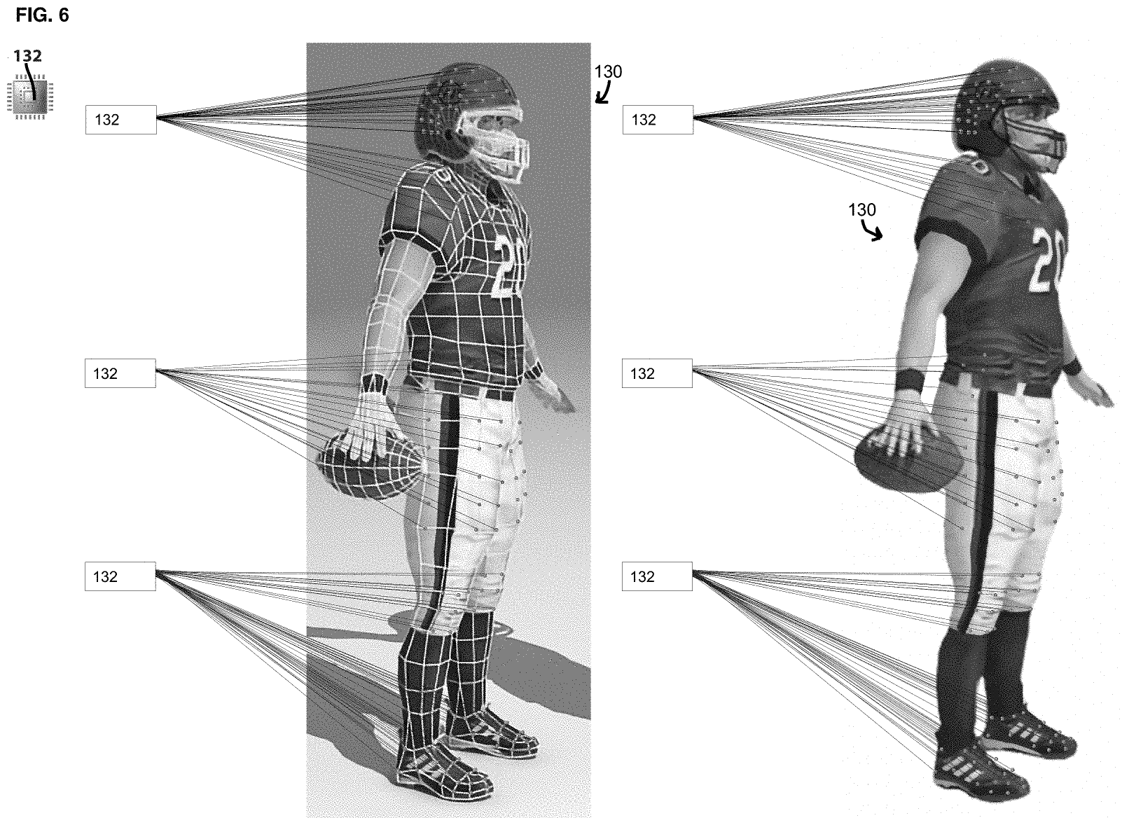

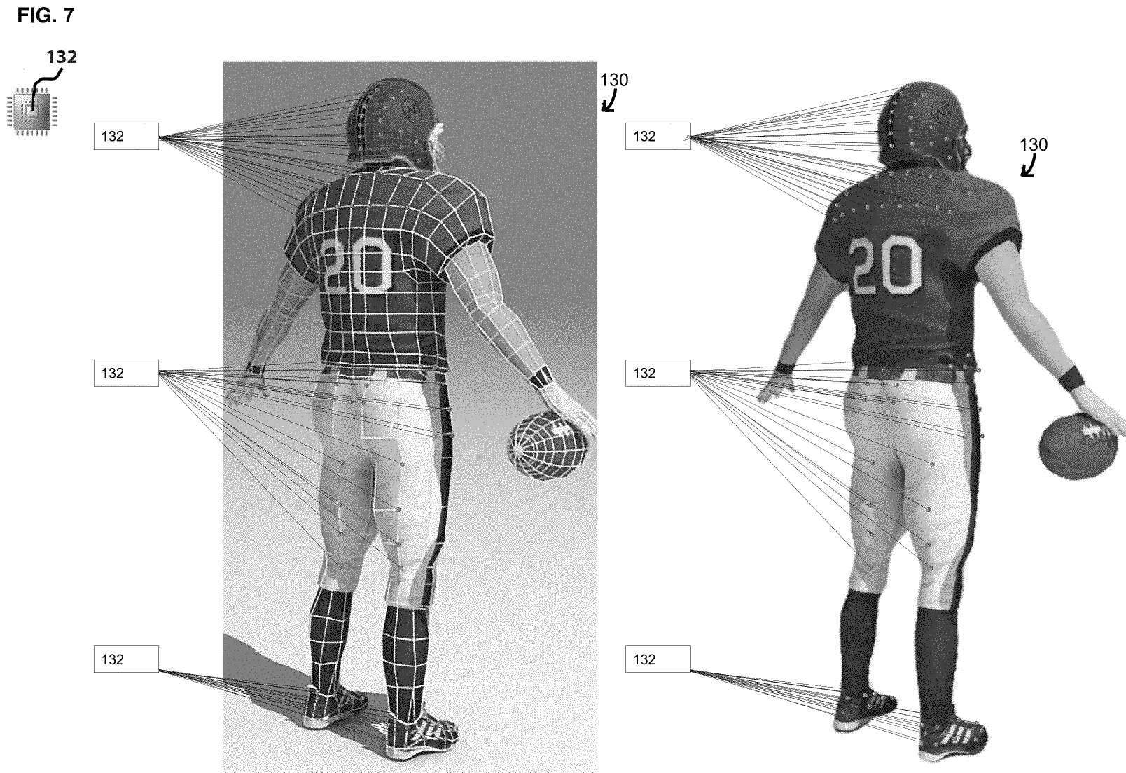

FIG. 5 shows an illustrative front view of a player 130 wearing equipment with player sensors 132 placed throughout the equipment. FIG. 6 shows and illustrative side view of player's equipment with player sensors 132 placed throughout the equipment. FIG. 7 shows an illustrative rear view of player's equipment with player sensors 132 placed throughout the equipment. Player sensors 132 may be placed in shoes, clothing, pads, helmets, sticks such as hockey sticks (ice or field hockey), lacrosse sticks, hurling stick (hurl or hurley) or a billiard stick; bats such as cricket bats, baseball bats, rackets or paddles such as tennis rackets, racquetball rackets, or squash rackets; or clubs such as a hurling club or a croquet mallet.

In the example illustrations multiple player sensors 132 are used for each player 130. In some embodiments each player may have a single player sensor 132. The player sensor 132 may be used in conjunction with the ball sensor 122 to determine officiating results. The ball sensor 122 may determine if the ball is moving in the same direction and at the same speed with approximately the same location as a player 130, to determine that the player 130 has control of the ball of sport. The ball sensor 122 may determine rotation of the ball, or lack of rotation to determine if a ball of sport 120 is being held or controlled by a player 130, or if the ball of sport is being passed, kicked, thrown, hit or otherwise out of the direct control of a single player. When a ball of sport 120 is determined by analysis of a ball sensor 122 and a player sensor 132 to be in control by a single control player, the player sensors 132 may be detected by the field generator if the player crosses or breaks the sensor detection field 110. An officiating result may be determined by a processor when a player sensor crosses or breaks a sensor detection field, for example when a player in control of a ball of sport crosses a boundary line, and the player, or part of the player's body is out of bounds. Player sensors may also be used to determine the boundaries of a detection field, such as a strike zone in baseball, which is based on the size of the player.

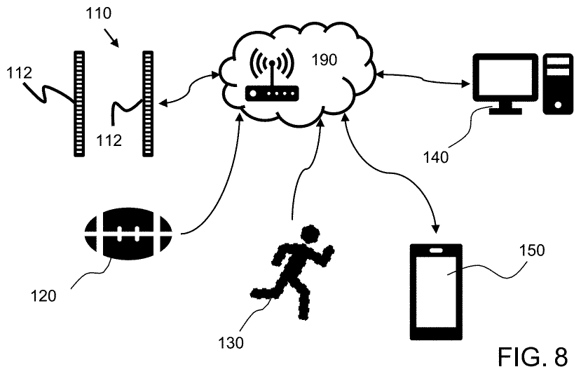

FIG. 8 is an illustrative system for assisting in officiating in a sporting event. The sensor detection field 110 may include a first and second sensor array or field generator 112 that create the sensor detection field. The sensor detection field 110 may communicate with a wireless communication system 190, and may send and receive data from the wireless communication system 190. A ball of sport 120 may include ball sensors that communicate wirelessly with the wireless communication system 190. The wireless communication system 190 may include a location detection system to determine the location of individual ball sensors 122 and player sensors 132. The wireless communication system 190 may receive data regarding the location of the ball of sport 120 and a player 130. In some embodiments the wireless communication system 190 may send data to the ball of sport 120 or the player 130. The wireless communication system may also communicate with a processor 140. The processor may include nonvolatile memory, and the play data may be stored in the nonvolatile memory. The field generators 112 may send play data to the processor 140 through the wireless communication system when a ball sensor 122 or a player sensor 132 breaks the detection field. The processor may determine an officiating result based on the play data and send the officiating result to an official's mobile device 150 to assist an official in officiating in the sporting event.

In some embodiments the processor 140 receives a confirmation from the official's mobile device that indicates whether the official agrees with the officiating result and may be a confirmation of the officiating result. The player sensor 132 may be a participant sensor, and may send participant data to the processor 140 through the wireless communication system 190.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles.

What is claimed is:

1. A method of officiating a sporting event with a player on a field of play with a play boundary comprising:
providing a ball sensor in a ball of sport;
providing a field generator to create a detection field along the play boundary;
detecting, by the field generator, the ball sensor breaking the detection field;
sending play data from the field generator to a processor with indication of the ball sensor breaking the detection field;
determining, by the processor, based on the play data, an officiating result;
sending the officiating result from the processor to an official's mobile device to assist in officiating the sporting event.

2. The method according to claim 1 wherein the detection field approximates a goal line.

3. The method according to claim 1 wherein a second field generator creates a second detection field at a second boundary line.

4. The method according to claim 1 wherein the detection field approximates a strike zone.

5. The method according to claim 1 wherein the detection field includes a first detection field that approximates a goal line of a football field, and a second detection field that approximates a first down line on the football field.

6. The method according to claim 1, further comprising:
receiving, from the official's mobile device, a confirmation of the officiating result.

7. The method according to claim 1, further comprising:
providing participant equipment with a participant sensor;
receiving, by the processor, participant data received from the participant sensor, and storing the participant data in the nonvolatile memory; and
wherein the determining the officiating result is based on the participant data.

8. A system for officiating in a sporting event with a player on a field of play with a play boundary, the system comprising:
a ball of sport with a ball sensor;
a field generator producing a sensor detection field along the play boundary;
a processor;
nonvolatile memory communicatively connected to the processor;
play data received from the field generator and stored in the nonvolatile memory;
an officiating module that receives the play data and determines officiating result data based on the play data;
a wireless communication system between the field generator and the processor;
an official's mobile device that receives the officiating result data.

9. The system according to claim 8, further comprising:
participant equipment with a participant sensor;
wherein the nonvolatile memory includes participant data received from the participant sensor; and
wherein the officiating module receives participant data and determines the officiating result data based on the participant data.

10. The system of claim 8, wherein the field generator creates a sensor plane approximating a field boundary on the field of play.
